(19) United States
(12) Patent Application Publication
(10) Pub. No.: US 2023/0056979 A1
(43) Pub. Date: Feb. 23, 2023

(54) PAPER FEEDING DEVICE

(71) Applicant: TOSHIBA TEC KABUSHIKI KAISHA, Tokyo (JP)

(72) Inventor: Takafumi Amano, Yokohama Kanagawa (JP)

(21) Appl. No.: 17/406,342

(22) Filed: Aug. 19, 2021

(51) Int. Cl. B65H 3/06; B41J 13/10

(52) U.S. Cl. CPC B65H 3/0669; B41J 13/103; B65H 3/0684; B65H 2801/06

(57) ABSTRACT

A first conveying unit is allowed to be in contact with a print medium loaded on an uppermost portion of the one or more print media loaded on a print medium loading unit to convey the print medium from the uppermost portion. The first moving unit moves at least one of the one or more print media and the first conveying unit in each of directions in which the uppermost portion and the first conveying unit are close to each other and directions in which the uppermost portion and the first conveying unit are far away from each other.

### FIELD

Embodiments described herein relate generally to paper feeding devices.

### BACKGROUND

In the related art, there is known a paper feeding device that picks up and conveys a print medium loaded on a tray by a pickup roller. In the paper feeding device, as the print medium becomes thicker, if the print medium is picked up by the pickup roller, a force with which the print medium tends to lift the pickup roller upward becomes higher. This is because a bending strength of the print medium becomes higher as a thickness of the print medium increases. If the pickup roller is lifted upward by the print medium, the pickup roller may fail to convey the print medium. This problem can be solved by increasing a force of pressing the pickup roller against the print medium. However, if the force of pressing the pickup roller against the print medium is increased, the pickup roller may pick up a plurality of the print media. This is not desirable because double feeding of the print media is caused to occur.

### DESCRIPTION OF THE DRAWINGS

FIG. 1 is a diagram illustrating an example of a configuration of a paper feeding device.

FIG. 2 is a diagram illustrating an example of a state inside a print medium accommodating unit accommodating one or more print media.

FIG. 3 is a diagram illustrating an example of a state in which a first conveying unit is pushed upward by the print medium.

FIG. 4 is a diagram illustrating an example of a state in which a position of a contact portion of the first conveying unit coincides with a second position.

FIG. 5 is a diagram illustrating an example of a state in which a print medium fails to be conveyed in the conveying direction if the position of the contact portion of the first conveying unit coincides with the second position.

FIG. 6 is a diagram illustrating an example of a state in which a first moving unit is moved by an electromagnet.

FIG. 7 is a hardware configuration diagram of an image forming apparatus.

FIG. 8 is a diagram illustrating an example of a flow of a first process performed by a control unit.

FIG. 9 is a diagram illustrating an example of a flow of a second process performed by the control unit.

### DETAILED DESCRIPTION

Hereinafter, a paper feeding device according to one embodiment will be described with reference to the drawings, exemplifying a paper feeding device 1. A three-dimensional coordinate system TC drawn in some figures is a three-dimensional Cartesian coordinate system indicating directions in each figure in which the three-dimensional coordinate system TC is drawn. For the convenience of description, an X-axis in the three-dimensional coordinate system TC will be referred to simply as an X-axis. For the convenience of description, a Y-axis in the three-dimensional coordinate system TC will be referred to simply as a Y-axis. For the convenience of description, a Z-axis in the three-dimensional coordinate system TC will be referred to simply as a Z-axis. As an example, a case where the negative direction of the Z axis and a direction of gravity coincide with each other will be described. For the convenience of description, the positive direction of the Z axis will be referred to as upward or simply upper. For the convenience of description, the negative direction of the Z axis will be referred to as downward or simply lower.

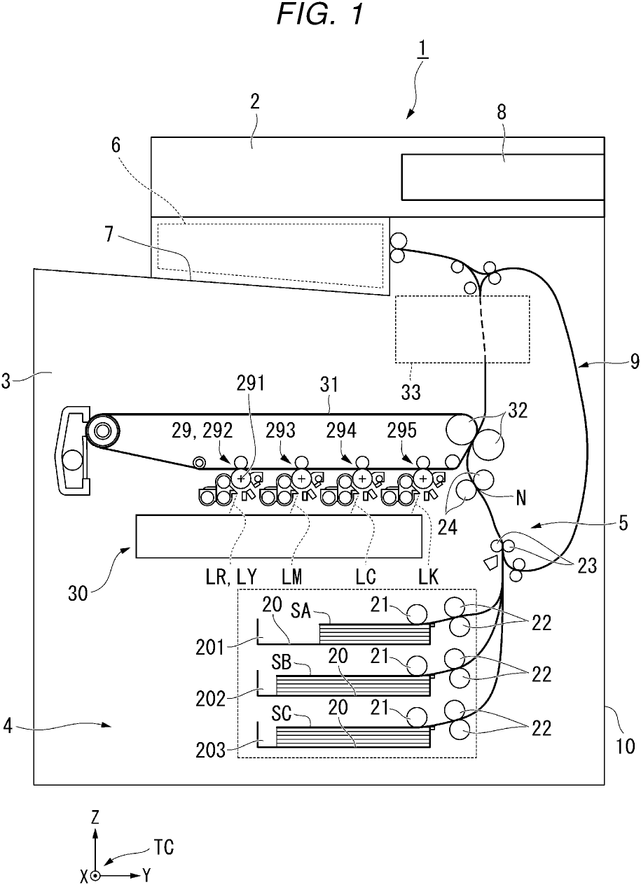

FIG. 1 is a diagram illustrating an example of a configuration of the paper feeding device 1.

The paper feeding device 1 may be any device as long as the device can supply a sheet-shaped print medium to an internal or external device. As an example, a case where the paper feeding device 1 is integrally configured with an image forming apparatus will be described. The image forming apparatus is, for example, a multifunction apparatus, but is not limited thereto. The paper feeding device 1 may be configured separately from the image forming apparatus. In this case, the paper feeding device 1 is mounted on the image forming apparatus and supplies the print medium to the image forming apparatus. The paper feeding device 1 may be integrally configured with an apparatus other than the image forming apparatus among the apparatuses using the print medium supplied by the paper feeding device 1. The paper feeding device 1 may be configured separately from an apparatus other than the image forming apparatus among the apparatuses using the print medium supplied by the paper feeding device 1 and configured to supply the print medium to the apparatus.

The paper feeding device 1 includes a housing 10, a scanner unit 2, an image forming unit 3, a print medium supplying unit 4, a conveying unit 5, a paper ejection tray 7, a reversing unit 9, a control panel 8, and a control unit 6.

The housing 10 forms the outer shape of the paper feeding device 1.

The scanner unit 2 reads image information of a copy object as brightness of light. The scanner unit 2 generates an image signal according to the brightness of the read light. The scanner unit 2 outputs the generated image signal to the image forming unit 3.

The image forming unit 3 forms an output image with a recording agent such as toner based on the image signal received from the scanner unit 2 or an image signal received from the outside. Hereinafter, for the convenience of description, the output image will be referred to as a toner image. The image forming unit 3 transfers the formed toner image to a surface of the print medium. The image forming unit 3 heats and pressurizes the toner image transferred to the surface of the print medium to fix the toner image on the print medium.

The print medium supplying unit 4 supplies the print media one by one to the conveying unit 5 in accordance with the timing when the image forming unit 3 forms the toner image. The print medium supplying unit 4 includes three print medium accommodating units of a print medium accommodating unit 201, a print medium accommodating unit 202, and a print medium accommodating unit 203. The print medium supplying unit 4 includes a print medium loading unit 20, a first conveying unit 21, and a second conveying unit 22 for each of the three print medium accommodating units.

The print medium accommodating unit 201 accommodates print media of a predetermined first size and a predetermined first type. For example, the print medium accommodating unit 201 is a paper feed cassette. The print medium accommodating unit 201 can be detached by pulling out from the print medium supplying unit 4 and can be attached by pushing into the print medium supplying unit 4. In other words, the print medium accommodating unit 201 can be mounted on the paper feeding device 1. The print medium of the first size is, for example, a print medium of an A4 size, but may be a print medium of another size. The print medium of the first type is, for example, plain paper, but is not limited thereto. The plain paper is an example of the print medium having a bending strength of a predetermined first strength, that is, the print medium having a bending strength of the first strength. A print medium SA illustrated in FIG. 1 illustrates an example of the print medium accommodated in the print medium accommodating unit 201.

In the print medium accommodating unit 201, the one or more print media SA is loaded on the print medium loading unit 20. The print medium loading unit 20 is, for example, a tray on which the one or more print media SA can be loaded. The print medium loading unit 20 may be another member on which the one or more print media SA can be loaded instead of the tray.

In the print medium accommodating unit 201, the first conveying unit 21 is in contact with the print medium SA loaded on an uppermost portion of the one or more print media SA loaded on the print medium loading unit 201 and conveys the print medium SA from the uppermost portion. The first conveying unit 21 includes, for example, a pickup roller PK. More specifically, the first conveying unit 21 picks up the print media SA one by one from the print medium accommodating unit 201 by the pickup roller PK. The first conveying unit 21 supplies the picked-up print medium SA to the second conveying unit 22. The first conveying unit 21 may be configured to include a different member such as a pickup belt as long as the member is a member capable of conveying the print medium SA from the uppermost portion instead of the pickup roller PK.

In the print medium accommodating unit 201, the second conveying unit 22 conveys the print medium SA supplied from the first conveying unit 21 to the conveying unit 5. The second conveying unit 22 is configured with two rollers of a paper feed roller and a separation roller.

The print medium accommodating unit 202 accommodates print media of a predetermined first size and a predetermined second type. For example, the print medium accommodating unit 202 is a paper feed cassette. The print medium accommodating unit 202 can be detached by pulling out from the print medium supplying unit 4 and can be attached by pushing into the print medium supplying unit 4. In other words, the print medium accommodating unit 202 can be mounted on the paper feeding device 1. The print medium of the second type is, for example, thick paper, but is not limited thereto. The thick paper is an example of the print medium having a bending strength of a second strength higher than the first strength, that is, the print medium having a bending strength of the second strength. A print medium SB illustrated in FIG. 1 illustrates an example of the print medium accommodated in the print medium accommodating unit 202.

Since the configuration of the print medium accommodating unit 202 is the same as the configuration of the print medium accommodating unit 201, detailed description thereof will be omitted.

The print medium accommodating unit 203 accommodates print media of a predetermined second size and a predetermined first type. For example, the print medium accommodating unit 203 is a paper feed cassette. The print medium accommodating unit 203 can be detached by pulling out from the print medium supplying unit 4 and can be attached by pushing into the print medium supplying unit 4. In other words, the print medium accommodating unit 203 can be mounted on the paper feeding device 1. The print medium of the second size is, for example, a print medium of an A3 size, but may be a print medium of another size. A print medium SC illustrated in FIG. 1 illustrates an example of the print medium accommodated in the print medium accommodating unit 203.

Since the configuration of the print medium accommodating unit 203 is the same as the configuration of the print medium accommodating unit 201, a detailed description thereof will be omitted.

With such a configuration, the print medium supplying unit 4 supplies the print media one by one from any of the print medium accommodating unit 201 to the print medium accommodating unit 203 to the conveying unit 5 in accordance with the timing when the image forming unit 3 forms the toner image.

The conveying unit 5 conveys the print medium supplied from the print medium supplying unit 4 to the image forming unit 3. The conveying unit 5 is a vertical convey roller configured with a convey roller 23 and a registration roller 24.

The convey roller 23 conveys the print medium supplied from the second conveying unit 22 to the registration roller 24. The convey roller 23 abuts a tip of the print medium in the conveying direction against a nip N of the registration roller 24.

The registration roller 24 adjusts a position of the tip of the print medium in the conveying direction by bending the print medium at the nip N. The registration roller 24 conveys the print medium supplied from the convey roller 23 to the image forming unit 3 according to the timing at which the image forming unit 3 transfers the toner image to the print medium.

Hereinafter, the image forming unit 3 will be described in detail.

The image forming unit 3 includes a plurality of image forming units 29, a laser scanning unit 30, an intermediate transfer belt 31, a transfer unit 32, and a fixing device 33.

The image forming unit 29 has a photoconductor drum 291. The image forming unit 29 forms the toner image corresponding to the image signal received from the scanner unit 2 or the image signal received from the outside on the photoconductor drum 291. The plurality of image forming units 292, 293, 294, and 295 form the toner images with yellow, magenta, cyan, and black toners, respectively.

A charger, a developing device, and the like are arranged around the photoconductor drum 291. The charger charges a surface of the photoconductor drum 291. The developing device contains a developer containing yellow, magenta, cyan, and black toners. The developing device develops an electrostatic latent image on the photoconductor drum 291. As a result, the toner image of toner of each color is formed on the photoconductor drum 291.

The laser scanning unit 30 scans the charged photoconductor drum 291 with a laser beam LR to expose the photoconductor drum 291. The laser scanning unit 30 exposes the photoconductor drums 291 of the image forming units 292, 293, 294, and 295 of the respective colors with different laser beams LY, LM, LC, and LK. As a result, the laser scanning unit 30 forms the electrostatic latent image on the photoconductor drum 291.

The toner image on the surface of the photoconductor drum 291 is primarily transferred to the intermediate transfer belt 31.

The transfer unit 32 transfers the toner image primarily transferred to the intermediate transfer belt 31 to the surface of the print medium supplied from the registration roller 24 at a secondary transfer position.

The fixing device 33 fixes the toner image on the print medium by heating and pressurizing the toner image transferred to the print medium in the transfer unit 32.

The reversing unit 9 reverses the print medium in order to form an image on a back surface of the print medium. The reversing unit 9 reverses the print medium discharged from the fixing device 33 by switching back. The reversing unit 9 conveys the reversed print medium toward the registration roller 24.

The print medium on which the image is formed is ejected and loaded on the paper ejection tray 7.

The control panel 8 is a portion of an input unit that inputs information for an operator to operate the paper feeding device 1. The control panel 8 has a touch panel, various hard keys, and the like.

The control unit 6 controls each unit of the paper feeding device 1. A position of the control unit 6 illustrated in FIG. 1 is only an example, and may be another position inside the paper feeding device 1. The control unit 6 is a functional unit provided in the image forming apparatus if the paper feeding device 1 is configured separately from the image forming apparatus. That is, in this case, the paper feeding device 1 is controlled by the control unit 6 of the image forming apparatus . However, if the paper feeding device 1 and the image forming apparatus are separate bodies, a functional unit that implements a portion or all of the functions of the control unit 6 may be provided in the paper feeding device 1. This functional unit may be a processor such as a central processing unit (CPU) or a hardware functional unit such as a field programmable gate array (FPGA).

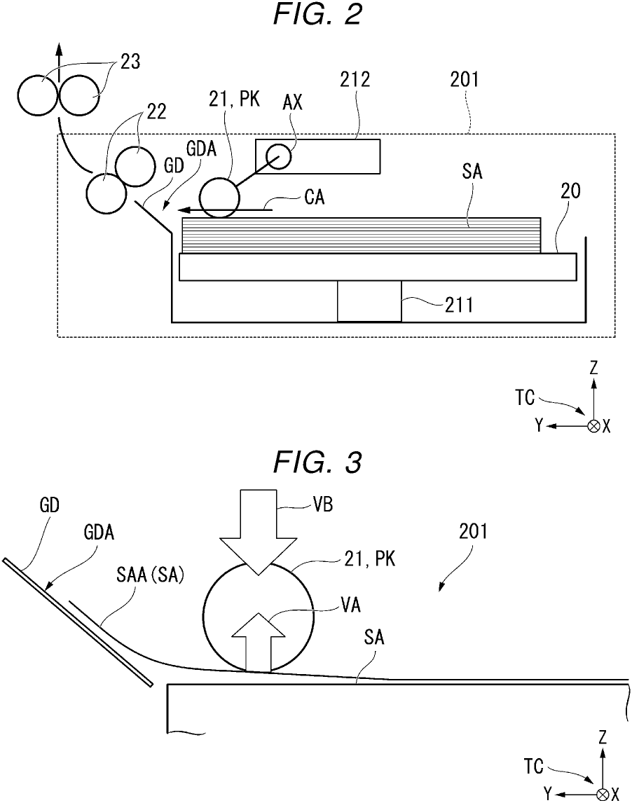

Hereinafter, the print medium supplying unit 4 will be described in more detail by exemplifying the print medium accommodating unit 201 with reference to FIG. 2. FIG. 2 is a diagram illustrating an example of a state inside the print medium accommodating unit 201 accommodating the one or more print media SA.

The print medium accommodating unit 201 further includes a first moving unit 211 in addition to the print medium loading unit 20, the first conveying unit 21, and the second conveying unit 22.

The first moving unit 211 moves at least one of the one or more print media SA loaded on the print medium loading unit 20 and the first conveying unit 21 in each of first and second directions according to the control from the processor included in the paper feeding device 1. The first direction is a direction in which the uppermost portion of the one or more print media SA and the first conveying unit 21 are close to each other. The second direction is a direction in which the uppermost portion and the first conveying unit 21 are far apart from each other. As an example, a case where the first moving unit 211 moves the one or more print media SA loaded on the print medium loading unit 20 in the first direction and the second direction according to the control from the processor included in the paper feeding device 1 will be described. As an example, a case where the first moving unit 211 ascends the entire print medium loading unit 20 to move the one or more print media SA in the first direction will be described. As an example, a case where the first moving unit 211 descends the entire print medium loading unit 20 to move the one or more print media SA in the second direction will be described.

The first moving unit 211 allows the first conveying unit 21 to be in contact with the uppermost portion by moving the one or more print media SA in the first direction. As a result, the first conveying unit 21 is in a state where the print medium SA can be conveyed from the uppermost portion. In FIG. 2, in order to simplify the figure, the first moving unit 211 is drawn as a quadrangular member. For this reason, the position of the first moving unit 211 illustrated in FIG. 2 does not necessarily coincide with the position where the first moving unit 211 is actually located in the print medium accommodating unit 201. For the convenience of description, the uppermost portion of the one or more print media SA loaded on the print medium loading unit 20 will be referred to simply as the uppermost portion.

The first conveying unit 21 is rotatably supported around a support member AX by the support member AX fixed at a predetermined position in the print medium accommodating unit 201. For this reason, if the first conveying unit 21 is in contact with the print medium SA, the first conveying unit 21 presses the print medium SA downward (that is, in the direction of gravity) by the own weight. The first conveying unit 21 conveys the print medium SA in contact with the first conveying unit 21 in the conveying direction by using a frictional force generated if the first conveying unit 21 presses the print medium SA. An arrow CA illustrated in FIG. 2 indicates the conveying direction of the print medium SA conveyed by the first conveying unit 21 in the print medium accommodating unit 201. In the example illustrated in FIG. 2, the conveying direction coincides with the positive direction of the Y axis.

The print medium SA conveyed in the conveying direction by the first conveying unit 21 is guided toward the second conveying unit 22 by a guide unit GD included in the print medium accommodating unit 201. That is, the print medium accommodating unit 201 further includes the guide unit GD.

The guide unit GD is a member having an inclined plane GDA that guides the print medium SA conveyed by the first conveying unit 21 to the second conveying unit 22. The inclined plane GDA is an inclined plane of which height increases toward the conveying direction.

In the print medium accommodating unit 201, since the print medium SA is an elastic body, if the print medium SA is guided toward the second conveying unit 22 along the inclined plane GDA of the guide unit GD, the first conveying unit 21 tends to be pushed upward by an elastic force. FIG. 3 is a diagram illustrating an example of a state in which the first conveying unit 21 is pushed upward by the print medium SA. The print medium SAA illustrated in FIG. 3 illustrates an example of the print medium SA of the uppermost portion. An arrow VA illustrated in FIG. 3 indicates an example of the direction of the force on which the print medium SAA tends to push upward the first conveying unit 21. An arrow VB illustrated in FIG. 3 indicates an example of the own weight of the first conveying unit 21, that is, a direction of gravity acting on the first conveying unit 21. As the magnitude of the force indicated by the arrow VA becomes greater with respect to the magnitude of the force indicated by the arrow VB, the print medium SAA tends to be ascended from the print medium SA directly below the print medium SAA. As a result, the first conveying unit 21 may fail to convey the print medium SAA in the conveying direction. As described above, as the bending strength of the print medium SA becomes higher, the magnitude of the force for lifting the first conveying unit 21 upward becomes greater. For example, the bending strength of thick paper is higher than the bending strength of plain paper. Therefore, in the case where the print medium SA is thick paper, there is a high possibility that the print medium SAA may lift the first conveying unit 21 upward in the print medium accommodating unit 201 in comparison with the case where the print medium SA is plain paper.

Therefore, as illustrated in FIG. 2, the print medium accommodating unit 201 is further provided with a second moving unit 212. If the print medium SA is a print medium having a bending strength of the first strength, the second moving unit 212 moves the first conveying unit 21 so that the position of the contact portion P in contact with the uppermost portion among the portions of the first conveying unit 21 coincides with the first position PA in the conveying direction. The contact portion P can be rephrased as a portion that is in contact with the uppermost portion among the portions of the pickup roller PK of the first conveying unit 21. The first strength is, for example, a strength equal to or lower than the bending strength of plain paper, but the first strength is not limited thereto. If the print medium SA is a print medium having a bending strength of the second strength, the second moving unit 212 moves the first conveying unit 21 so that the position of the contact portion P coincides with the second position PB on the upstream side of the first position PA in the conveying direction. The second strength is higher than the first strength, and is, for example, the bending strength of thick paper, but is not limited thereto.

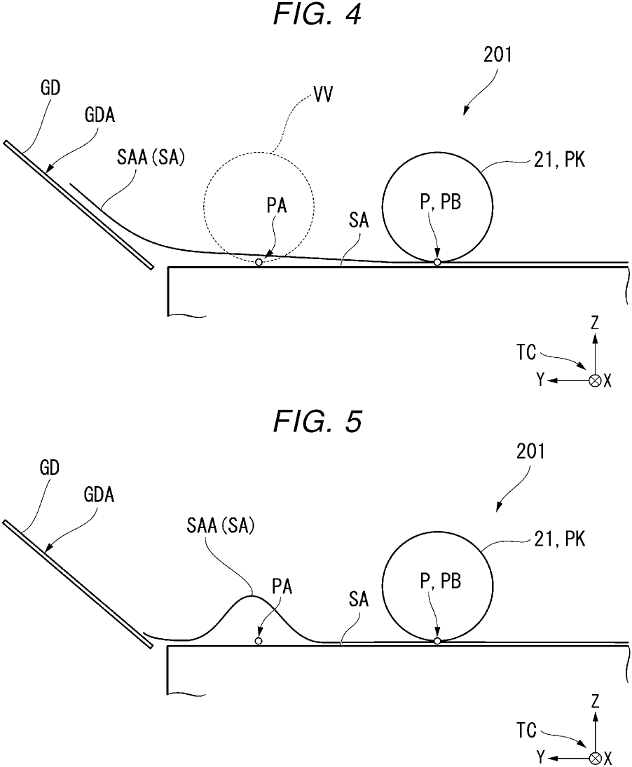

FIG. 4 is a diagram illustrating an example of a state in which the position of the contact portion P of the first conveying unit 21 coincides with the position of the second position PB. As illustrated in FIG. 4, the second position PB is located on the upstream side of the first position PA in the conveying direction. The second position PB may be any position as long as the second position is a position on the upstream side of the first position PA in the conveying direction and is difficult to receive a force of lifting upward by the print medium SAA. The second position PB may have a height different from the height of the first position PA or may have the same height as the height of the first position PA. In the example illustrated in FIG. 4, the height of the second position PB is the same as the height of the first position PA. This is because, in this example, the first moving unit 211 ascends and descends the entire print medium loading unit 20. As a result, even if the contact position P coincides with any position of the first position PA or the second position PB, the first conveying unit 21 can press the print medium SA of the uppermost portion downward with substantially the same force.

If the position of the contact portion P of the first conveying unit 21 coincides with the position of the second position PB, the first conveying unit 21 is less likely to receive a force to be lifted upward by the print medium SAA. Therefore, even if the print medium SAA is lifted upward from the print medium SA directly under the print medium SAA, the first conveying unit 21 cannot be lifted upward by the print medium SAA. As a result, even if the bending strength of the print medium SA is equal to or higher than the second strength, the first conveying unit 21 can suppress the print medium SA from failing to be conveyed in the conveying direction. A dotted line VV illustrated in FIG. 4 illustrates an example of the contour of the first conveying unit 21 if the position of the contact portion P coincides with the first position PA.

On the other hand, in the case where the bending strength of the print medium SA is equal to or lower than the first strength, if the position of the contact portion P of the first conveying unit 21 coincides with the second position PB, the first conveying unit 21 may fail to convey the print medium SAA in the conveying direction. FIG. 5 is a diagram illustrating an example of a state in which the print medium SAA fails to be conveyed in the conveying direction if the position of the contact portion P of the first conveying unit 21 coincides with the second position PB. For this reason, as illustrated in FIG. 5, the print medium SAA having a bending strength of the first strength or lower may be blocked to be conveyed in the conveying direction by the frictional force of the inclined plane GDA of the guide unit GD. This is caused by the fact that most of the force that tends to convey the print medium SAA in the conveying direction escapes in the direction where the force tends to bend the print medium SAA. It is not desirable that the frictional force of the inclined plane GDA blocks the conveying of the print medium SAA in the conveying direction, which causes paper jam. Under these circumstances, if the print medium SA is a print medium having a bending strength of the first strength, the second moving unit 212 moves the first conveying unit 21 so that the position of the contact portion P coincides with the first position PA in the conveying direction.

The second moving unit 212 includes, for example, an electromagnet MG and moves the first conveying unit 21 according to generation of a magnetic force by the electromagnet MG. The electromagnet MG is, for example, a solenoid coil, but is not limited thereto.

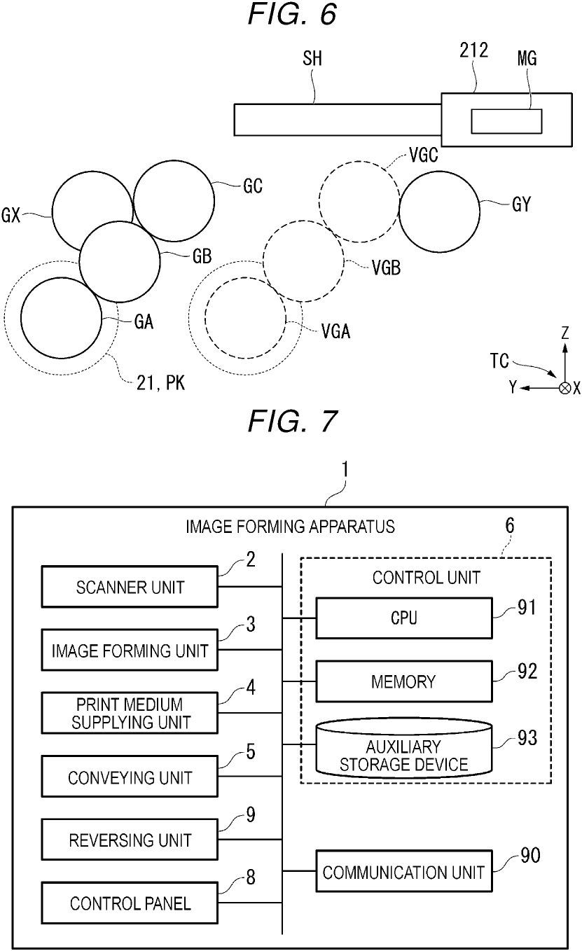

FIG. 6 is a diagram illustrating an example of a state in which the first moving unit 211 is moved by the electromagnet MG. In the example illustrated in FIG. 6, the first moving unit 211 is moved by the second moving unit 212 together with a gear train that rotates the pickup roller PK of the first moving unit 211. This gear train may be provided in the first moving unit 211 or may be provided in other than the first moving unit 211. This gear train is configured with three gears of a gear GA, a gear GB, and a gear GC illustrated in FIG. 6. The gear GA is a gear that rotates together with the pickup roller PK of the first conveying unit 21. The gear GB is a gear that is engaged with the gear GA and rotates the gear GA. The gear GC is a gear that is engaged with the gear GB and rotates the gear GB.

Such a gear train moves substantially in parallel to the conveying direction in the print medium accommodating unit 201 in accordance with the movement of a member SH included in the second moving unit 212. In FIG. 6, in order to prevent the drawing from becoming complicated, a member connecting the member SH and the gear train is omitted.

If the electromagnet MG does not generate a magnetic force, the member SH is urged to the downstream side in the conveying direction by an urging member such as a spring. If the member SH is located at the most downstream position in the conveying direction among the positions where the member SH can be located, the position of the contact portion P of the first conveying unit 21 coincides with the first position PA. If the contact portion P of the first conveying unit 21 coincides with the first position PA, the gear GC is engaged with a gear GX. The gear GX is a gear that rotates the pickup roller PK of the first conveying unit 21 by rotating the gear GC. In FIG. 6, the position of the contact portion P of the first conveying unit 21 coincides with the position of the first position PA. Therefore, the gear GC is engaged with the gear GX.

On the other hand, if the electromagnet MG generates a magnetic force, the member SH is moved to the upstream side in the conveying direction by the magnetic force . If the member SH is located at the most upstream position in the conveying direction among the positions where the member SH can be located, the position of the contact portion P of the first conveying unit 21 coincides with the second position PB. If the contact portion P of the first conveying unit 21 coincides with the second position PB, the gear GC is engaged with a gear GY. The gear GY is a gear different from the gear GX, and is a gear that rotates the pickup roller PK of the first conveying unit 21 by rotating the gear GC. A dotted line VGC illustrated in FIG. 6 illustrates an example of the contour of the gear GC if the gear GC is engaged with the gear GY. A dotted line VGB illustrated in FIG. 6 illustrates an example of the contour of the gear GB if the gear GC is engaged with the gear GY. A dotted line VGA illustrated in FIG. 6 illustrates an example of the contour of the gear GA if the gear GC is engaged with the gear GY. In FIG. 6, the contour of the first conveying unit 21 if the gear GC is engaged with the gear GY is omitted in order to prevent the drawing from becoming complicated.

The configuration of the second moving unit 212 may be another configuration in which the first conveying unit 21 can be moved instead of the configuration described with reference to FIG. 6. For example, the second moving unit 212 may have a configuration in which the first conveying unit 21 can be moved by a rack and a pinion.

With the above configuration, the print medium supplying unit 4 provided with the print medium accommodating unit 201 can suppress the occurrence of paper jam according to the bending strength of the print medium SA. Since the configuration of each of the print medium accommodating unit 202 and the print medium accommodating unit 203 is the same as the configuration of the print medium accommodating unit 201, a detailed description thereof will be omitted. Any one of the print medium accommodating unit 202 and the print medium accommodating unit 203 may have a configuration different from that of the print medium accommodating unit 201.

FIG. 7 is a hardware configuration diagram of an image forming apparatus 1. The image forming apparatus 1 includes a CPU 91, a memory 92, an auxiliary storage device 93, and the like connected by a bus and executes various programs. The image forming apparatus 1 functions as an apparatus including the scanner unit 2, the image forming unit 3, the print medium supplying unit 4, the conveying unit 5, the reversing unit 9, the control panel 8, and a communication unit 90 by executing various programs.

The CPU 91 functions as the control unit 6 by executing various programs stored in the memory 92 and the auxiliary storage device 93. The control unit 6 controls the operation of each functional unit of the image forming apparatus 1.

The auxiliary storage device 93 is configured by using a storage device such as a magnetic hard disk device or a semiconductor storage device. The auxiliary storage device 93 stores various types of information.

The communication unit 90 includes a communication interface for connecting an own device to an external device. The communication unit 90 communicates with the external device via the communication interface.

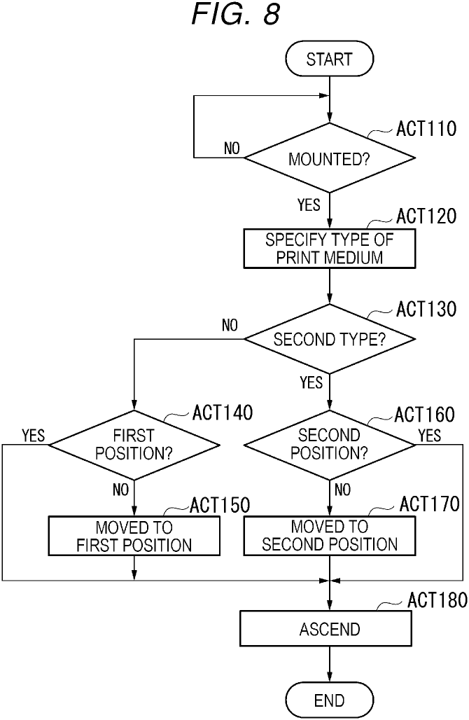

Hereinafter, the first process performed by the control unit 6 will be described with reference to FIG. 8. FIG. 8 is a diagram illustrating an example of the flow of the first process performed by the control unit 6. The first process is an example of the process performed by the control unit 6 if each of the print medium accommodating unit 201, the print medium accommodating unit 202, and the print medium accommodating unit 203 is mounted on the paper feeding device 1. As an example, a case where all of the print medium accommodating unit 201, the print medium accommodating unit 202, and the print medium accommodating unit 203 are not mounted on the paper feeding device 1 at the timing before the process of ACT110 illustrated in FIG. 8 is performed will be described. As an example, a case where the control unit 6 receives the type information via the control panel 8 at the timing will be described. If the control unit 6 receives the type information, the control unit 6 allows the auxiliary storage device 93 to store the received type information. That is, as an example, a case where the type information is stored in the auxiliary storage device 93 at the timing will be described. The type information is information indicating the type of the print medium accommodated in the print medium accommodating unit for each of the print medium accommodating unit 201, the print medium accommodating unit 202, and the print medium accommodating unit 203.

The control unit 6 waits until any of the print medium accommodating unit 201, the print medium accommodating unit 202, and the print medium accommodating unit 203 is mounted on the paper feeding device 1 (ACT110). For example, the control unit 6 can specify whether or not each of the print medium accommodating unit 201, the print medium accommodating unit 202, and the print medium accommodating unit 203 is mounted on the paper feeding device 1 based on the output signal from a cassette sensor included in the print medium supplying unit 4. The cassette sensor is a sensor that detects for each of the print medium accommodating unit 201, the print medium accommodating unit 202, and the print medium accommodating unit 203 in which the print medium accommodating unit is mounted on the paper feeding device 1. For example, if the print medium accommodating unit 201 is mounted on the paper feeding device 1, the cassette sensor outputs an output signal indicating that the print medium accommodating unit 201 is mounted on the paper feeding device 1 to the control unit 6. On the other hand, for example, the cassette sensor does not output the output signal to the control unit 6 if the print medium accommodating unit 201 is not mounted on the paper feeding device 1. As an example, a case where the print medium accommodating unit 201 is mounted on the paper feeding device 1 in ACT110 will be described.

If the control unit 6 determines that the print medium accommodating unit 201 is mounted on the paper feeding device 1 (YES in ACT110), the control unit 6 specifies the type of the print medium accommodated in the print medium accommodating unit 201 (ACT120) . For example, the control unit 6 acquires the type information from the auxiliary storage device 93. The control unit 6 specifies the type of the print medium accommodated in the print medium accommodating unit 201 based on the acquired type information. The control unit 6 may be configured to specify the type of the print medium accommodated in the print medium accommodating unit 201 by another method in ACT120.

The control unit 6 determines whether or not the type specified in ACT120 is the second type (ACT130). In ACT130, the control unit 6 may be configured to determine whether or not the bending strength of the print medium of the type specified in ACT120 is equal to or higher than the second strength. In this case, for example, the auxiliary storage device 93 stores in advance the corresponding information where the type of the print medium is associated with the bending strength of the print medium. Then, in ACT130, the control unit 6 determines whether or not the bending strength of the print medium of the type specified in ACT120 is equal to or higher than the second strength based on the corresponding information.

If the control unit 6 determines that the type specified in ACT120 is the first type (NO in ACT130), the control unit 6 determines whether or not the position of the contact portion P is the first position PA (ACT140) . For example, the control unit 6 can determine whether or not the position of the contact portion P is the first position PA depending on whether or not a current is flowing through the electromagnet MG. The control unit 6 may be configured to determine whether or not the position of the contact portion P is the first position PA by another method.

If the control unit 6 determines that the position of the contact portion P is the first position PA (YES in ACT140), the control unit 6 controls the first moving unit 211 to move the print medium loading unit 20 in the first direction (ACT180) . As a result, the control unit 6 allows the first conveying unit 21 to be in contact with the uppermost portion. Then, the control unit 6 allows the processes of the flowchart illustrated in FIG. 8 to be ended. In FIG. 8, the process of ACT180 is indicated by “ascending ”.

On the other hand, if the control unit 6 determines that the position of the contact portion P is the second position PB (NO in ACT140), the control unit 6 controls the second moving unit 212 to move the first conveying unit 21, so that the contact portion P is moved from the second position PB to the first position PA (ACT150) . After the process of ACT150 is performed, the control unit 6 transitions to ACT180 and controls the first moving unit 211 to move the print medium loading unit 20 in the first direction. As a result, the control unit 6 allows the first conveying unit 21 to be in contact with the uppermost portion.

On the other hand, if the control unit 6 determines that the type specified in ACT130 is the second type (YES in ACT130), the control unit 6 determines whether or not the position of the contact portion P is the second position PB (ACT160) . Since the method for determining the position of the contact portion P in ACT160 is the same as the determination method in ACT140, a detailed description thereof will be omitted.

If the control unit 6 determines that the position of the contact portion P is the second position PB (YES in ACT160), the control unit 6 transitions to ACT180 and controls the first moving unit 211 to move the print medium loading unit 20 in the first direction. As a result, the control unit 6 allows the first conveying unit 21 to be contact with the uppermost portion.

On the other hand, if the control unit 6 determines that the position of the contact portion P is the first position PA (NO in ACT160), the control unit 6 controls the second moving unit 212 to move the first conveying unit 21, so that the contact portion P is moved to the second position PB (ACT170) . After the process of ACT170 is performed, the control unit 6 transitions to ACT180 and controls the first moving unit 211 to move the print medium loading unit 20 in the first direction. As a result, the control unit 6 allows the first conveying unit 21 to be in contact with the uppermost portion.

As described in FIG. 8, in the case where the print medium accommodating unit 201, the print medium accommodating unit 202, and the print medium accommodating unit 203 are mounted on the paper feeding device 1, if the one or more print media is a print medium having a bending strength of the second strength, the paper feeding device 1 allows the first conveying unit 21 to be moved so that the position of the contact portion P coincides with the position of the second position PB. In addition, in this case, if the one or more print media is print media having a bending strength of the first strength, the paper feeding device 1 moves the first conveying unit 21 so that the position of the contact portion P coincides with the first position PB. Accordingly, the paper feeding device 1 can suppress the occurrence of paper jam due to the high bending strength of the print medium.

In the processes of the flowchart illustrated in FIG. 8, the paper feeding device 1 moves the first conveying unit 21 if the first conveying unit 21 and the print medium of the uppermost portion are not in contact with each other. As a result, the paper feeding device 1 can suppress the occurrence of paper jam due to the movement of the first conveying unit 21 and can suppress the occurrence of paper jam due to the difference in the bending strength of the print medium.

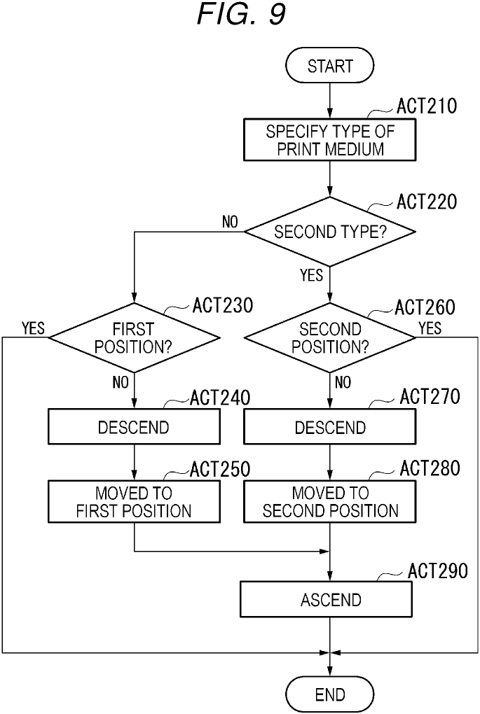

Hereinafter, the second process performed by the control unit 6 will be described with reference to FIG. 9. FIG. 9 is a diagram illustrating an example of the flow of the second process performed by the control unit 6. The second process is an example of a process performed by the control unit 6 if the paper feeding device 1 receives an operation of starting printing by receiving a print job or the like. As an example, a case where the paper feeding device 1 receives the operation of starting printing at the timing before the process of ACT210 illustrated in FIG. 9 is performed in the control unit 6 will be described. As an example, a case where the print medium accommodating unit 201 is designated as an accommodating destination of the print media used for printing started by the operation will be described. As an example, a case where the control unit 6 receives the type information via the control panel 8 at the timing will be described. That is, as an example, a case where the type information is stored in the auxiliary storage device 93 at the timing will be described.

The control unit 6 specifies the type of the print medium accommodated in the print medium accommodating unit 201 designated in advance as the accommodating destination of the print media (ACT210) . In ACT210, the control unit 6 specifies the type of the print medium accommodated in the print medium accommodating unit 201 based on the type information stored in advance in the auxiliary storage device 93. In ACT210, the control unit 6 may be configured to specify whether or not the bending strength of the print medium accommodated in the print medium accommodating unit 201 is equal to or higher than the second strength. In this case, for example, the auxiliary storage device 93 stores in advance the corresponding information where the type of the print medium is associated with the bending strength of the print medium. Then, in ACT210, the control unit 6 specifies whether or not the bending strength of the print medium accommodated in the print medium accommodating unit 201 is equal to or higher than the second strength based on the corresponding information.

The control unit 6 determines whether or not the type specified in ACT210 is the second type (ACT220). In ACT220, the control unit 6 may be configured to determine whether or not the bending strength of print medium of the type specified in ACT210 is equal to or higher than the second strength. In this case, for example, the auxiliary storage device 93 stores in advance the corresponding information where the type of the print medium is associated with the bending strength of the print medium. Then, in ACT220, the control unit 6 determines whether or not the bending strength of the type of print medium specified in ACT210 is equal to or higher than the second strength based on the corresponding information.

If the control unit 6 determines that the type specified in ACT210 is the first type (NO in ACT220), the control unit 6 determines whether or not the position of the contact portion P is the first position PA (ACT230) . The method for determining the position of the contact portion P in ACT230 is the same as the determination method in ACT140 illustrated in FIG. 8, detailed description thereof will be omitted.

If the control unit 6 determines that the position of the contact portion P is the first position PA (YES in ACT230), the processes of the flowchart illustrated in FIG. 9 are ended. Then, the control unit 6 starts the conveying of the print medium accommodated in the print medium accommodating unit 201 and the printing on the print medium. In the specification, the description of the conveying process and the printing process performed by the control unit 6 will be omitted.

On the other hand, if the control unit 6 determines that the position of the contact portion P is the second position PB (NO in ACT230), the control unit 6 controls the first moving unit 211 to move the print medium loading unit 20 in the second direction (ACT240) . As a result, the control unit 6 separates the first conveying unit 21 from the uppermost portion. In FIG. 9, the process of ACT240 is indicated by “descending”.

Next, the control unit 6 controls the second moving unit 212 to move the first conveying unit 21, so that the contact portion P is moved from the second position PB to the first position PA (ACT250).

Next, the control unit 6 controls the first moving unit 211 to move the print medium loading unit 20 in the first direction (ACT290). As a result, the control unit 6 allows the first conveying unit 21 to be contact with the uppermost portion. In FIG. 9, the process of ACT290 is indicated by “ascending”. After the process of ACT290 is performed, the control unit 6 allows the processes of the flowchart illustrated in FIG. 9 to be ended. Then, the control unit 6 starts the conveying of the print medium accommodated in the print medium accommodating unit 201 and the printing on the print medium.

On the other hand, if the control unit 6 determines that the type specified in ACT210 is the second type (YES in ACT220), the control unit 6 determines whether or not the position of the contact portion P is the second position PB (ACT260) . Since the method for determining the position of the contact portion P in ACT260 is the same as the determination method in ACT140 illustrated in FIG. 8, a detailed description thereof will be omitted.

If the control unit 6 determines that the position of the contact portion P is the second position PB (YES in ACT260), the processes of the flowchart illustrated in FIG. 9 are ended. Then, the control unit 6 starts the conveying of the print medium accommodated in the print medium accommodating unit 201 and the printing on the print medium.

On the other hand, if the control unit 6 determines that the position of the contact portion P is the first position PA (NO in ACT260), the control unit 6 controls the first moving unit 211 to move the print medium loading unit 20 in the second direction (ACT270) . As a result, the control unit 6 separates the first conveying unit 21 from the uppermost portion. In FIG. 9, the process of ACT270 is indicated by “descending”.

Next, the control unit 6 controls the second moving unit 212 to move the first conveying unit 21, so that the contact portion P is moved from the first position PA to the second position PB (ACT280).

Next, the control unit 6 transitions to ACT290 and controls the first moving unit 211 to move the print medium loading unit 20 in the first direction. As a result, the control unit 6 allows the first conveying unit 21 to be in contact with the uppermost portion.

As described in FIG. 9, if the paper feeding device 1 starts printing by receiving a print job or the like, if the one or more print media is a print medium having a bending strength of the second strength, the paper feeding device 1 allows the first conveying unit 21 to move so that the position of the contact portion P coincides with the second position PB. In addition, in this case, if the one or more print media is print media having a bending strength of the first strength, the paper feeding device 1 allows the first conveying unit 21 to move so that the position of the contact portion P coincides with the first position PB. Also with these, the paper feeding device 1 can suppress the occurrence of paper jam due to the high bending strength of the print medium.

Even in the processes of the flowchart illustrated in FIG. 9, the paper feeding device 1 moves the first conveying unit 21 if the first conveying unit 21 and the print medium of the uppermost portion are not in contact with each other. Accordingly, the paper feeding device 1 can suppress the occurrence of paper jam due to the movement of the first conveying unit 21 and can suppress the occurrence of paper jam due to the difference in the bending strength of the print medium.

The print medium of the second-strength described above may be a print medium having a radio frequency tag, a seal mount, coated paper, or the like, instead of thick paper.

The paper feeding device 1 described above may be configured to move the contact portion P to any of three or more positions according to the bending strength of the print medium or the type of the print medium. Accordingly, the paper feeding device 1 can more reliably suppress the occurrence of paper jam due to the difference in the bending strength of the print medium.

As described above, the paper feeding device (paper feeding device 1 in this example) includes a print medium loading unit (print medium loading unit 20 in this example), a first conveying unit (first conveying unit 21 in this example) , a first moving unit (first moving unit 211 in this example), and a second moving unit (second moving unit 212 in this example). The print medium loading unit is loaded with the one or more print media. The first conveying unit is allowed to be in contact with the print medium loaded on the uppermost portion of the one or more print media loaded on the print medium loading unit to convey the print medium from the uppermost portion. The first moving unit moves at least one of the one or more print media and the first conveying unit in each of directions (first direction in this example) in which the uppermost portion and the first conveying unit are close to each other and directions (second direction in this example) in which the uppermost portion and the first conveying unit are far away from each other. If the one or more print media is a print medium having a bending strength of a first strength (bending strength of plain paper in this example), the second moving unit moves the first conveying unit so that the position of the contact portion (contact portion P in this example) that is in contact with the uppermost portion among the portions of the first conveying unit coincides with the first position (first position PA in this example) in the conveying direction in which the print medium is conveyed by the first conveying unit. If the one or more print media is a print medium having a bending strength of a second strength (bending strength of thick paper in this example) higher than the first strength, the second moving unit moves the first conveying unit so that the position of the contact portion coincides with the second position (second position PB in this example) on the upstream side of the first position. If the one or more print media is a print medium having a bending strength of the first strength, after the second moving unit moves the contact position to the first position, the first moving unit allows the uppermost portion and the first conveying unit to be close to each other so that the first conveying unit and the uppermost portion are in contact with each other. If the one or more print media is print media having a bending strength of the second strength, after the second moving unit moves the contact position to the second position, the first moving unit allows the uppermost portion and the first conveying unit to be close to each other so that the first conveying unit and the uppermost portion are in contact with each other. Accordingly, the paper feeding device can suppress the occurrence of paper jam due to the high bending strength of the print medium.

In the paper feeding device, a configuration may be used in which the first conveying unit moves the first conveying unit if the first conveying unit and the uppermost portion of the print medium are not in contact with each other.

In the paper feeding device, a configuration may be used in which the paper feeding device further includes a control unit (control unit 6 in this example) that controls the second moving unit to move the first conveying unit so that the position of the contact portion coincides with the first position in the conveying direction if the one or more print media is print media having a bending strength of the first strength and controls the second moving unit to move the first conveying unit so that the position of the contact portion coincides with the second position in the conveying direction if the one or more print media is print media having a bending strength of the second strength.

In the paper feeding device, a configuration may be used in which the paper feeding device is mounted on an image forming apparatus, the control unit acquires type information indicating a type of one or more print media from the image forming apparatus and controls the first moving unit and the second moving unit based on the acquired type information, a first type of the print medium among the types of the one or more print media is a print medium having a bending strength of the first strength, and a second type of the print medium among the types of the one or more print media is a print medium having a bending strength of the second strength.

In the paper feeding device, a configuration may be used in which the paper feeding device further includes a second conveying unit (second conveying unit 22 in this example) that conveys the print medium conveyed by the first conveying unit to a conveyance path and a guide unit (guide unit GD in this example) having an inclined plane (inclined plane GDA in this example) that guides the print medium conveyed by the first conveying unit to a second conveyance path, and the inclined plane has a height increasing toward the conveying direction.

In the paper feeding device, a configuration may be used in which the second moving unit includes an electromagnet (electromagnet MG in this example) and moves the first conveying unit according to generation of a magnetic force by the electromagnet.

In the paper feeding device, a configuration may be used in which the first conveying unit includes a pickup roller (pickup roller PK in this example) and one or more gears (gear train in this example) rotating the pickup roller, and the paper feeding device includes a first gear (gear GX in this example) rotating one or more gears of the first conveying unit if a position of the first conveying unit is a first position and a second gear (gear GY in this example) rotating the one or more gears of the first conveying unit if the position of the first conveying unit is a second position.

In the paper feeding device, a configuration may be used in which the first conveying unit moves the one or more print media in each of the directions in which the uppermost portion and the first conveying unit are close to each other and the directions in which the uppermost portion and the first conveying unit are far away from each other.

In the paper feeding device, a configuration may be used in which the paper feeding device includes a support member (support member AX in this example) supporting the first conveying unit, and the first conveying unit is rotatably supported around the support member and, if the first conveying unit is in contact with the uppermost portion, the uppermost portion is pressed in a direction of gravity by an own weight of the first conveying unit.

In the paper feeding device, a configuration may be used in which the height of the first position and the height of the second position are the same.

It is noted that a program for implementing the functions of any components in the device (for example, the paper feeding device 1) described above may be recorded on a computer-readable recording medium, and the program may be read into a computer system and executed. It is noted that the term “computer system” as used herein includes hardware such as an operating system (OS) and peripheral devices. The “computer-readable recording medium” refers to a portable medium such as a flexible disk, a magneto-optical disk, a ROM, a compact disk (CD)-ROM, or a storage device such as a hard disk built in a computer system. Furthermore, a “computer-readable recording medium” is assumed to include a recording medium storing a program for a certain period of time such as a volatile memory (RAM) inside a computer system that serves as a server or client if the program is transmitted via a network such as the Internet or a communication line such as a telephone line.

In addition, the above-mentioned program may be transmitted from a computer system in which the program is stored in a storage device or the like via a transmission medium or may be transmitted to another computer system by a transmission wave in the transmission medium. Herein, the “transmission medium” for transmitting a program refers to a medium having a function of transmitting information, such as a network (communication network) such as the Internet or a communication channel (communication line) such as a telephone line.

In addition, the above-mentioned program may be for implementing a portion of the above-mentioned functions. Furthermore, the above-mentioned program may be a so-called difference file (difference program) that can implement the above-mentioned functions in combination with a program already recorded in the computer system.

While certain embodiments have been described these embodiments have been presented by way of example only, and are not intended to limit the scope of the inventions . Indeed, the novel embodiments described herein may be embodied in a variety of other forms; furthermore various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A paper feeding device, comprising:
a print medium loading component configured hold with one or more print media;
a first conveying component configured to be in contact with a print medium held on an uppermost portion of the one or more print media loaded on the print medium loading unit and convey the print medium from the uppermost portion;
a first moving component configured to move at least one of the one or more print media and the first conveying component in each of directions in which the uppermost portion and the first conveying component are close to each other and directions in which the uppermost portion and the first conveying component are far away from each other; and
a second moving component configured to move the first conveying component so that a position of a contact portion that contacts with the uppermost portion among the portions of the first conveying component coincides with the first position in a conveying direction in which the print medium is conveyed by the first conveying component if the one or more print media is a print medium having a bending strength of a first strength and to move the first conveying component so that the position of the contact portion coincides with the second position on the upstream side of the first position in the conveying direction if the one or more print media is a print medium having a bending strength of a second strength higher than the first strength,
wherein, if the one or more print media is a print medium having the bending strength of the first strength, after the second moving component moves the contact position to the first position, the first moving component allows the uppermost portion and the first conveying component to be close to each other so that the first conveying component and the uppermost portion are in contact with each other, and if the one or more print media is print media having the bending strength of the second strength, after the second moving component moves the contact position to the second position, the first moving component allows the uppermost portion and the first conveying component to be close to each other so that the first conveying component and the uppermost portion are in contact with each other.

2. The paper feeding device according to claim 1, wherein the first moving component moves the first conveying component if the first conveying component and the print medium of the uppermost portion are not in contact with each other.

3. The paper feeding device according to claim 1, further comprising a controller that controls the second moving component to move the first conveying component so that the position of the contact portion coincides with the first position in the conveying direction if the one or more print media is print media having the bending strength of the first strength and controls the second moving component to move the first conveying component so that the position of the contact portion coincides with the second position in the conveying direction if the one or more print media is print media having the bending strength of the second strength.

4. The paper feeding device according to claim 1,
wherein the paper feeding device is mounted on an image forming apparatus,
wherein the controller acquires type information indicating a type of one or more print media from the image forming apparatus and controls the first moving component and the second moving component based on the acquired type information,
wherein a first type of the print medium among the types of the one or more print media is a print medium having the bending strength of the first strength, and
wherein a second type of the print medium among the types of the one or more print media is a print medium having the bending strength of the second strength.

5. The paper feeding device according to claim 1, further comprising:
a second conveying component that conveys the print medium conveyed by the first conveying component to a conveyance path; and
a guide component having an inclined plane that guides the print medium conveyed by the first conveying component to the second conveyance path,
wherein a height of the inclined plane increases along the conveying direction.

6. The paper feeding device according to claim 1, wherein the second moving component comprises an electromagnet and moves the first conveying component according to generation of a magnetic force by the electromagnet.

7. The paper feeding device according to claim 1,
wherein the first conveying component comprises a pickup roller and one or more gears that rotate the pickup roller, and
wherein the paper feeding device comprises:
a first gear that rotates the one or more gears of the first conveying component if a position of the first conveying component is the first position; and
a second gear that rotates the one or more gears of the first conveying component if the position of the first conveying component is the second position.

8. The paper feeding device according to claim 1, wherein the first conveying component moves the one or more print media in each of directions in which the uppermost portion and the first conveying component are close to each other and directions in which the uppermost portion and the first conveying component are far away from each other.

9. The paper feeding device according to claim 1, further comprising a support member that supports the first conveying component,
wherein, if the first conveying component is rotatably supported around the support member and is in contact with the uppermost portion, the uppermost portion is pressed in a direction of gravity by its own weight of the first conveying component.

10. The paper feeding device according to claim 1, wherein a height of the first position and a height of the second position are equal.

11. A paper feeding method, comprising:
contacting a first conveying component with a print medium held on an uppermost portion of one or more print media loaded on a print medium loading unit and conveying the print medium from the uppermost portion;
moving at least one of the one or more print media and the first conveying component using a first moving component in each of directions in which the uppermost portion and the first conveying component are close to each other and directions in which the uppermost portion and the first conveying component are far away from each other;
moving the first conveying component using a second moving component so that a position of a contact portion that contacts with the uppermost portion among the portions of the first conveying component coincides with the first position in a conveying direction in which the print medium is conveyed by the first conveying component if the one or more print media is a print medium having a bending strength of a first strength and moving the first conveying component so that the position of the contact portion coincides with the second position on the upstream side of the first position in the conveying direction if the one or more print media is a print medium having a bending strength of a second strength higher than the first strength;
if the one or more print media is a print medium having the bending strength of the first strength, after the second moving component moves the contact position to the first position, allowing the uppermost portion and the first conveying component to be close to each other so that the first conveying component and the uppermost portion are in contact with each other; and
if the one or more print media is print media having the bending strength of the second strength, after the second moving component moves the contact position to the second position, allowing the uppermost portion and the first conveying component to be close to each other so that the first conveying component and the uppermost portion are in contact with each other.

12. The paper feeding method according to claim 11, further comprising:
moving the first conveying component if the first conveying component and the print medium of the uppermost portion are not in contact with each other.

13. The paper feeding method according to claim 11, further comprising:
controlling the second moving component to move the first conveying component so that the position of the contact portion coincides with the first position in the conveying direction if the one or more print media is print media having the bending strength of the first strength and controlling the second moving component to move the first conveying component so that the position of the contact portion coincides with the second position in the conveying direction if the one or more print media is print media having the bending strength of the second strength.

14. The paper feeding method according to claim 11, further comprising:
acquiring type information indicating a type of one or more print media from the image forming apparatus and controlling the first moving component and the second moving component based on the acquired type information.

15. The paper feeding method according to claim 11, further comprising:
conveying the print medium conveyed by the first conveying component to a conveyance path; and
guiding the print medium conveyed by the first conveying component to the second conveyance path, wherein a height of an inclined plane increases along the conveying direction.

16. The paper feeding method according to claim 11, further comprising:
moving the first conveying component according to generation of a magnetic force by an electromagnet.

17. The paper feeding method according to claim 11, further comprising:
rotating one or more gears of the first conveying component if a position of the first conveying component is the first position; and
rotating one or more gears of the first conveying component if the position of the first conveying component is the second position.

18. The paper feeding method according to claim 11, further comprising:
moving the one or more print media in each of directions in which the uppermost portion and the first conveying component are close to each other and directions in which the uppermost portion and the first conveying component are far away from each other.

19. An image forming apparatus, comprising:
an image forming component; and
a paper feeding device, comprising:
a print medium loading component configured hold with one or more print media;
a first conveying component configured to be in contact with a print medium held on an uppermost portion of the one or more print media loaded on the print medium loading unit and convey the print medium from the uppermost portion;
a first moving component configured to move at least one of the one or more print media and the first conveying component in each of directions in which the uppermost portion and the first conveying component are close to each other and directions in which the uppermost portion and the first conveying component are far away from each other; and
a second moving component configured to move the first conveying component so that a position of a contact portion that contacts with the uppermost portion among the portions of the first conveying component coincides with the first position in a conveying direction in which the print medium is conveyed by the first conveying component if the one or more print media is a print medium having a bending strength of a first strength and to move the first conveying component so that the position of the contact portion coincides with the second position on the upstream side of the first position in the conveying direction if the one or more print media is a print medium having a bending strength of a second strength higher than the first strength,
wherein, if the one or more print media is a print medium having the bending strength of the first strength, after the second moving component moves the contact position to the first position, the first moving component allows the uppermost portion and the first conveying component to be close to each other so that the first conveying component and the uppermost portion are in contact with each other, and if the one or more print media is print media having the bending strength of the second strength, after the second moving component moves the contact position to the second position, the first moving component allows the uppermost portion and the first conveying component to be close to each other so that the first conveying component and the uppermost portion are in contact with each other.

20. The image forming apparatus according to claim 19, wherein a height of the first position and a height of the second position are equal.
